(19) United States
(12) Patent Application Publication
(10) Pub. No.: US 2019/0353206 A1
(43) Pub. Date: Nov. 21, 2019

(54) MANUFACTURING METHOD FOR BEARING DEVICE, AND BEARING DEVICE

(71) Applicant: JTEKT CORPORATION, Osaka (JP)

(72) Inventor: Akira KITAGAWA, Yao-Shi (JP)

(73) Assignee: JTEKT CORPORATION, Osaka (JP)

(21) Appl. No.: 16/405,535

(22) Filed: May 7, 2019

(30) Foreign Application Priority Data
May 15, 2018 (JP) 2018-093959

(51) Int. Cl. F16C 33/64; F16C 33/62; F16C 33/78; B60B 27/00

(52) U.S. Cl. CPC F16C 33/64; F16C 33/62; F16C 33/7806; B60B 27/0005; B60B 2310/654; F16C 2223/02; B60B 2380/73; B60B 2900/572; F16C 2326/02; F16C 2223/42; B60B 2380/12

(57) ABSTRACT

A manufacturing method for a bearing device includes a first coating process of applying a coating all over an outer ring member solely, a removal process of, after the first coating process, removing part of the coating by machining the outer ring member for forming an outer raceway surface with which rolling elements come into rolling contact, an assembling process of assembling the coated outer ring member, an inner shaft member, the rolling elements, and a cage into an assembly, and a second coating process of applying a coating to a required portion of the inner shaft member in the assembly.

### INCORPORATION BY REFERENCE

The disclosure of Japanese Patent Application No. 2018-093959 filed on May 15, 2018 including the specification, drawings and abstract is incorporated herein by reference in its entirety.

### BACKGROUND

### 1. Technical Field

The disclosure relates to a manufacturing method for a bearing device, and a bearing device.

### 2. Description of Related Art

A bearing device called a hub unit is used to mount a wheel and a brake disc on a body of an automobile. For example, when rust (particularly, red rust) is formed on a hub unit at the time when an owner of an automobile replaces a wheel or a brake disc, functionally it does not matter; however, the owner may not like the appearance. Therefore, efforts to prevent formation of rust are going to be made by applying a coating to the whole (almost the whole) of the hub unit. Japanese Unexamined Patent Application Publication No. 2005-239115 (JP 2005-239115 A) describes a hub unit with a rustproof coating. Raceway surfaces, and the like, with which rolling elements (mostly, balls) are in rolling contact, have no coating.

### SUMMARY

The hub unit includes an inner shaft member, an outer ring member, a plurality of rolling elements, and cages. The inner shaft member has a flange to which a wheel, or the like, is mounted. The outer ring member is fixed to a vehicle body side. The plurality of rolling elements is provided between the inner shaft member and the outer ring member. The cages hold the rolling elements. The following two methods are conceivable as a method of applying a coating to the whole (almost the whole) of such a hub unit.

Method 1: A coating is applied solely (in discrete components) all over each of the outer ring member and the inner shaft member (by, for example, hot-dip galvanizing), and then the outer ring member and the inner shaft member are assembled.

Method 2: After assembling of the outer ring member, the inner shaft member, the rolling elements, and the cages is complete, a coating is applied to required portions of the outer ring member and inner shaft member (by, for example, spray painting).

In the case of Method 1, a coating is applied to all over the outer ring member and all over the inner shaft member. Therefore, after coating, a coating on the raceway surfaces included in the inner periphery of the outer ring member needs to be removed by grinding the raceway surfaces, and a coating on the raceway surfaces included in the outer periphery of the inner shaft member needs to be removed by grinding the raceway surfaces. In this case, there is a step of removing a coating for each of the outer ring member and the inner shaft member, so there can be a lot of waste.

In the case of Method 2, to apply a coating, part of the hub unit needs to be held. There is inconvenience that, in an assembly resulting from completion of assembling, a portion that needs to be coated overlaps a portion to be held. That is, the outer ring member just needs to be held by a chuck from radially outer sides; however, a coating cannot be applied to the outer periphery (a portion held by the chuck) of the outer ring member.

The above-described inconvenience in Method 1 and Method 2 is not limited to a hub unit for an automobile, but the inconvenience can also arise in other bearing devices.

The disclosure provides a manufacturing method for a bearing device, which minimizes work for removing a coating to form a raceway surface and which is also able to avoid interference of holding of the bearing device with work for coating, and a bearing device that is manufactured through the manufacturing method.

A first aspect of the disclosure relates to a manufacturing method for a bearing device. The bearing device includes an inner shaft member, a cylindrical outer ring member that is provided on an outer side of the inner shaft member in a radial direction, a plurality of rolling elements that are provided between the inner shaft member and the outer ring member, and a cage that holds the plurality of rolling elements. The manufacturing method includes a first coating process of applying a coating solely all over a first member that is one of the inner shaft member and the outer ring member, a removal process of, after the first coating process, removing part of the coating by machining the first member for forming a raceway surface with which the rolling elements come into rolling contact, an assembling process of assembling the coated first member, a second member, the rolling elements, and the cage into an assembly, the second member being the other one of the inner shaft member and the outer ring member, and a second coating process of applying a coating to a required portion of the second member in the assembly.

This manufacturing method is a method in which a coating is applied solely all over the first member and a coating is applied to the second member after the assembly is formed. With this method, a coating is applied to the required portions of the inner shaft member and outer ring member, so it is possible to reduce formation of rust overall. In the case of the manufacturing method, work for removing part of the coating at the time of forming the raceway surface is performed only over the first member. In the second coating process, work for applying a coating to the required portion of the second member in the assembly is performed. At this time, it is possible to hold the already coated first member, so holding of the bearing device does not interfere with work for applying a coating to the second member.

In the manufacturing method, the first member may be the outer ring member, the second member may be the inner shaft member, the inner shaft member may include an inner shaft having a flange at one side in an axial direction, an inner ring that has annular shape and is mounted at the other side of the inner shaft in the axial direction, and a clinch portion that is part of the inner shaft and that is provided to prevent the inner ring from coming off to the other side in the axial direction, and, in the second coating process, a coating may be applied to one side of the inner shaft in the axial direction, including the flange. In this case, in the second coating process, no coating is applied to the raceway surface of the inner shaft member, and no coating is applied to the inner ring and the clinch portion.

In this case, the bearing device may further include a seal that is provided at one side of an annular space in the axial direction, the annular space being provided between the inner shaft member and the outer ring member, and, in the second coating process, a portion of the inner shaft member at one side in the axial direction, including the flange, may be placed inside a paint chamber, the other side in the axial direction where the seal and the clinch portion are provided may be placed outside the paint chamber, and work for applying a coating may be performed inside the paint chamber. In this case, the seal does not need to be masked.

A second aspect of the disclosure relates to a bearing device. The bearing device is a bearing device of which the first member is an outer ring member and of which the second member is an inner shaft member. The bearing device is manufactured through the manufacturing method. The bearing device includes an inner shaft member, a cylindrical outer ring member provided on an outer side of the inner shaft member in a radial direction, a plurality of rolling elements provided between the inner shaft member and the outer ring member, and a cage that holds the plurality of rolling elements. The inner shaft member includes an inner shaft, an inner ring that has annular shape, and a clinch portion. The inner shaft includes a flange at one side in an axial direction and a cylindrical portion that extends from the flange further toward the one side in the axial direction. The inner ring is mounted at the other side of the inner shaft in the axial direction. The clinch portion that is part of the inner shaft at the other side in the axial direction and is provided to prevent the inner ring from coming off to the other side in the axial direction. In the outer ring member, a raceway surface with which the rolling elements are in rolling contact is a metal surface, and an outer periphery is a coated surface. In the inner shaft member, a coating is applied to a portion at one side in the axial direction, including the flange and the cylindrical portion, and a raceway surface with which the rolling elements are in rolling contact, a surface of the inner ring, and a surface of the clinch portion are metal surfaces.

With this bearing device, a coating is applied to the required portions of the inner shaft member and outer ring member, so it is possible to reduce formation of rust overall.

The bearing device may further include a seal that is provided at one side of an annular space in the axial direction, the annular space being provided between the inner shaft member and the outer ring member. The seal may include an outer lip that covers part of an outer periphery of the outer ring member. In the coating of the inner shaft member, a finishing layer that is an outermost layer may be a continuous layer. Part of an outer periphery of the outer ring member may be a metal surface, and the metal surface and part of the coating that adjoins the metal surface may be covered with the outer lip. With this bearing device, it is favorable in appearance, and corrosion performance is high.

In the bearing device, the outer ring member and the inner shaft member may have the same specifications of coatings. Alternatively, the outer ring member and the inner shaft member may have different specifications of coatings. In this case, appropriate coatings can be respectively selected for the outer ring member and the inner shaft member.

With the manufacturing method according to the first aspect of the disclosure, work for removing a coating to form a raceway surface is minimized, and it is possible to avoid interference of holding of the bearing device with work for coating. The bearing device according to the second aspect of the disclosure can be manufactured by the manufacturing method, and is able to reduce formation of rust overall.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a cross-sectional view showing an example of a bearing device;

FIG. 2A is a view illustrating a manufacturing method for the bearing device;

FIG. 2B is a view illustrating the manufacturing method for the bearing device;

FIG. 2C is a view illustrating the manufacturing method for the bearing device;

FIG. 2D is a view illustrating the manufacturing method for the bearing device;

FIG. 2E is a view illustrating the manufacturing method for the bearing device;

FIG. 3A is a view illustrating the manufacturing method for the bearing device;

FIG. 3B is a view illustrating the manufacturing method for the bearing device;

FIG. 4 is an enlarged cross-sectional view showing a one-side end portion of an outer ring member in an axial direction;

FIG. 5 is a view illustrating a second coating process; and

FIG. 6 is an enlarged cross-sectional view illustrating an existing example and showing a one-side end portion of an outer ring member in an axial direction.

### DETAILED DESCRIPTION OF EMBODIMENTS

### Bearing Device

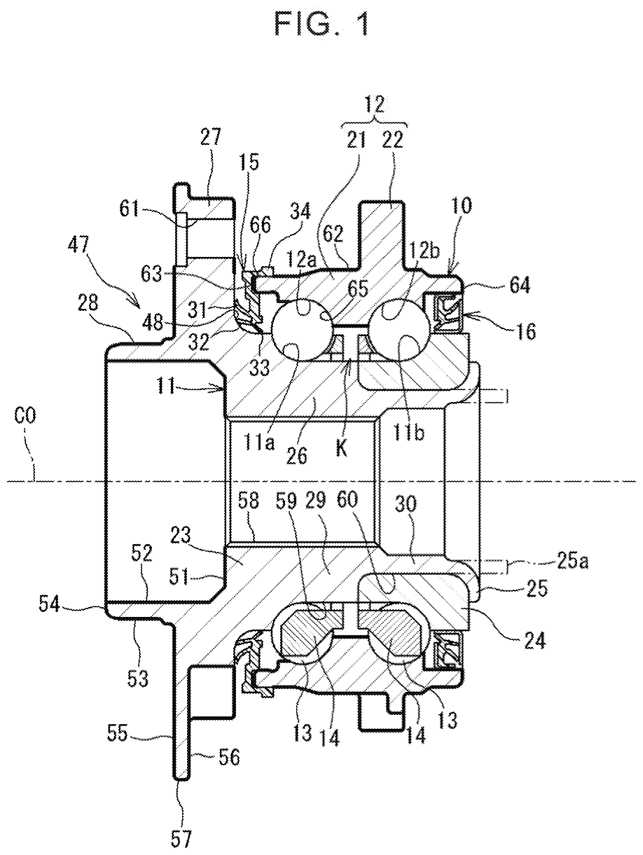

FIG. 1 is a cross-sectional view showing an example of a bearing device of the disclosure. The bearing device 10 shown in FIG. 1 is a so-called hub unit. The bearing device 10 is mounted on a suspension system (knuckle) that is provided in the body of an automobile. The bearing device 10 supports a wheel such that the wheel is rotatable. Although not shown in the drawing, a brake disc is mounted on the bearing device 10 in addition to the wheel. The bearing device 10 includes an inner shaft member 11, a cylindrical outer ring member 12, balls 13, cages 14, a first seal 15, and a second seal 16. The outer ring member 12 is provided on the outer side of the inner shaft member 11 in a radial direction. The balls 13 are rolling elements. The first seal 15 is provided at one side in an axial direction. The second seal 16 is provided at the other side in the axial direction. In the bearing device 10, the axial direction is a direction along a central axis CO of the bearing device 10 (hereinafter, referred to as bearing central axis CO), and a direction parallel to the bearing central axis CO is also referred to as axial direction. The radial direction is a direction perpendicular to the bearing central axis CO. The bearing device 10 has a coating.

The outer ring member 12 has a cylindrical outer ring body portion 21 and a fixing flange 22. The flange 22 is provided so as to extend toward the outer side in the radial direction from the outer ring body portion 21. Outer raceway surfaces 12a, 12b are formed on the inner peripheral side of the outer ring body portion 21. The outer ring member 12 is mounted on the knuckle (not shown) through the flange 22. The knuckle is a vehicle body-side member. Thus, the bearing device 10 including the outer ring member 12 is fixed to the vehicle body. In a state where the bearing device 10 is fixed to the vehicle body, a wheel mounting flange 27 (described later) side of the inner shaft member 11 is the outer side of the vehicle. That is, one side in the axial direction where the flange 27 is provided is a vehicle outer side, and the other side in the axial direction that is the opposite side is a vehicle inner side.

The inner shaft member 11 includes an inner shaft (hub spindle) 23 and an inner ring 24. The inner ring 24 is connected to the other side of the inner shaft 23 in the axial direction. The inner shaft 23 has a shaft body portion 26, the flange 27, a cylindrical portion 28, and a clinch portion 25. The shaft body portion 26 is provided on the inner side of the outer ring member 12 in the radial direction. The flange 27 is provided at one side of the shaft body portion 26 in the axial direction. The cylindrical portion 28 further protrudes from the flange 27 toward one side in the axial direction. The clinch portion 25 is used to prevent the inner ring 24 from coming off to the other side in the axial direction. The flange 27 is provided so as to extend from one side of the shaft body portion 26 in the axial direction toward the outer side in the radial direction. A wheel (not shown) and a brake rotor (not shown) are mounted on a face (flange face 55) of the flange 27 on one side in the axial direction. At the time when the wheel and the brake rotor are mounted on the flange 27, the wheel and the brake rotor are fitted onto the cylindrical portion 28 and are located in position. The cylindrical portion 28 is called a faucet engagement portion.

The clinch portion 25 is part of the other side of the inner shaft 23 in the axial direction. The clinch portion 25 is formed such that a cylindrical portion 25a is plastically deformed to increase in diameter. In FIG. 1, the cylindrical portion 25a before plastic deformation is shown by the long dashed double-short dashed line. The outer periphery of the shaft body portion 26 has a step shape. That is, the shaft body portion 26 has a first shaft portion 29 and a second shaft portion 30. An inner raceway surface 11a (described later) is formed on the first shaft portion 29. The second shaft portion 30 is smaller in diameter than the first shaft portion 29, and is provided on the other side of the first shaft portion 29 in the axial direction. In a state where the inner ring 24 is fitted onto the second shaft portion 30, the cylindrical portion 25a is plastically deformed to increase in diameter. Thus, the clinch portion 25 is formed. As a result, the inner ring 24 is sandwiched between the first shaft portion 29 and the clinch portion 25.

The inner ring 24 is an annular member. The inner ring 24 is fitted onto the second shaft portion 30 and is fixed to the second shaft portion 30. The first inner raceway surface 11a is formed on the outer periphery of the first shaft portion 29. A second inner raceway surface 11b is formed on the outer periphery of the inner ring 24. A plurality of the balls 13 is disposed between the outer raceway surface 12a and the inner raceway surface 11a at one side in the axial direction. A plurality of the balls 13 is disposed between the outer raceway surface 12b and the inner raceway surface 11b at the other side in the axial direction. Two rows of the balls 13 are provided between the outer ring member 12 and the inner shaft member 11. The balls 13 included in one of the rows are held by one of the cages 14. The balls 13 included in the other one of the rows are held by the other one of the cages 14.

The inner shaft 23, the inner ring 24, the outer ring member 12, and the balls 13, which are the constituent members of the bearing device 10, are made of a steel (a carbon steel or a bearing steel). The cages 14 may be made of a steel or may be made of a resin.

An annular space K is formed between the inner shaft member 11 and the outer ring member 12. The first seal 15 is provided on one side of the annular space K in the axial direction. The second seal 16 is provided on the other side of the annular space K in the axial direction. The seals 15, 16 prevent entry of external foreign matter into the annular space K. The seal 15 on one side in the axial direction has axial lips 31, 32 and a radial lip 33 made of rubber. The axial lips 31, 32 and the radial lip 33 are in contact with a sealing surface 48 of the inner shaft member 11 (or a slinger (not shown) fitted onto the inner shaft member 11). The seal 15 also has an outer lip 34 made of rubber.

The bearing device 10 having the above configuration has a coating. The area in which a coating is applied is as follows. In FIG. 1, the outlines of the coated portions are shown by the wide lines. In contrast to this, the outlines of the uncoated portions are shown by the lines narrower than the wide lines.

The area in which a coating is applied on the inner shaft member 11 includes the following surfaces.
One-side end face 51 of the inner shaft 23 in the axial direction
The whole (an inner periphery 52, an outer periphery 53, and a distal end face 54) of the cylindrical portion 28
The flange face 55 of the flange 27 at one side in the axial direction, an anti-flange face 56 of the flange 27 at the other side in the axial direction, and an outer periphery 57 of the flange 27

No coating is applied to the other area. That is, the area in which no coating is applied on the inner shaft member 11 includes the following surfaces.
An inner periphery 58 of the inner shaft 23
An outer periphery 59 of the first shaft portion 29, including the raceway surface 11a and the sealing surface 48
A surface 60 of the inner shaft 23, with which the inner ring 24 contacts
A surface of the inner ring 24
A surface of the clinch portion 25
A bolt hole 61 provided in the flange 27

In the case of the present embodiment, since the inner periphery 58 of the inner shaft 23 is a splined hole, no coating is required.

The area in which a coating is applied on the outer ring member 12 includes the following surfaces.
An outer periphery 62 including the flange 22 (however, other than a portion 66)
An end face 63 at one side in the axial direction and an end face 64 at the other side in the axial direction
An inner periphery other than the raceway surfaces 12a, 12b

No coating is applied to the other area. That is, the area in which no coating is applied on the outer ring member 12 includes the following surfaces.
The raceway surfaces 12a, 12b
The portion 66 of the outer periphery 62 at one side in the axial direction

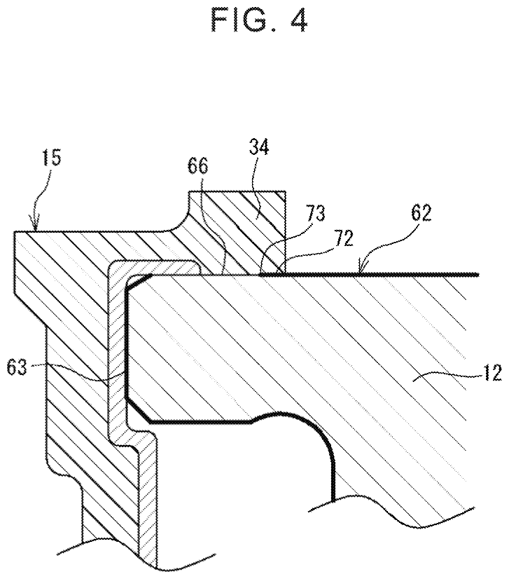

Although described later, in the outer ring member 12, surfaces on which no coating is applied are surfaces (machined surfaces: ground surfaces) from which a coating has been removed though machining (grinding). In the present embodiment, a coating is applied to a surface between the raceway surfaces 12a, 12b on the inner periphery 65; however, the coating may be removed by grinding the surface together with the raceway surfaces 12a, 12b in a grinding process (described later) (removal process). The portion 66 (see FIG. 4) of the outer periphery 62 is covered with the outer lip 34 of the seal 15.

### Manufacturing Method

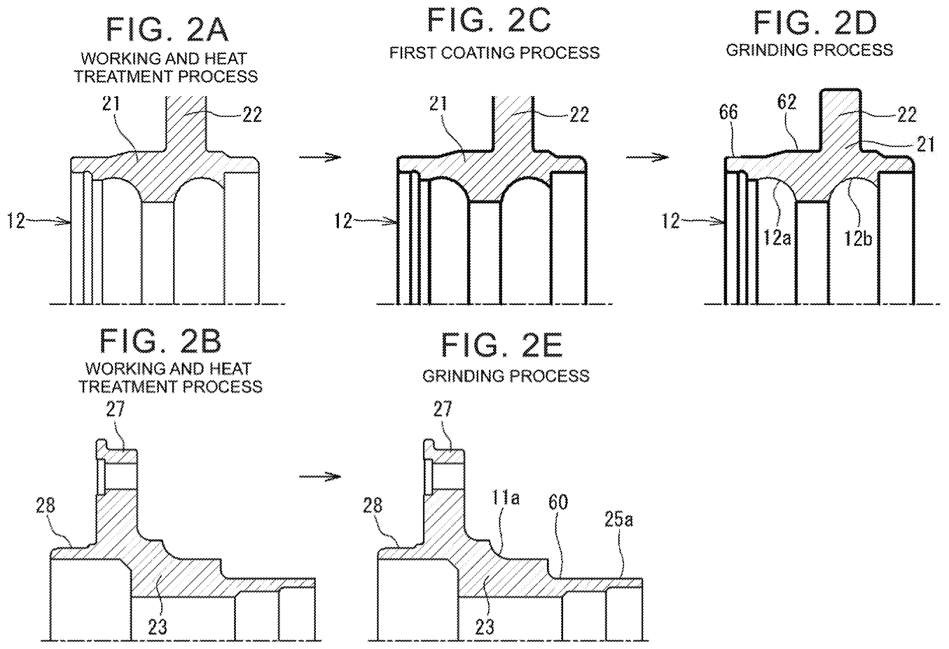

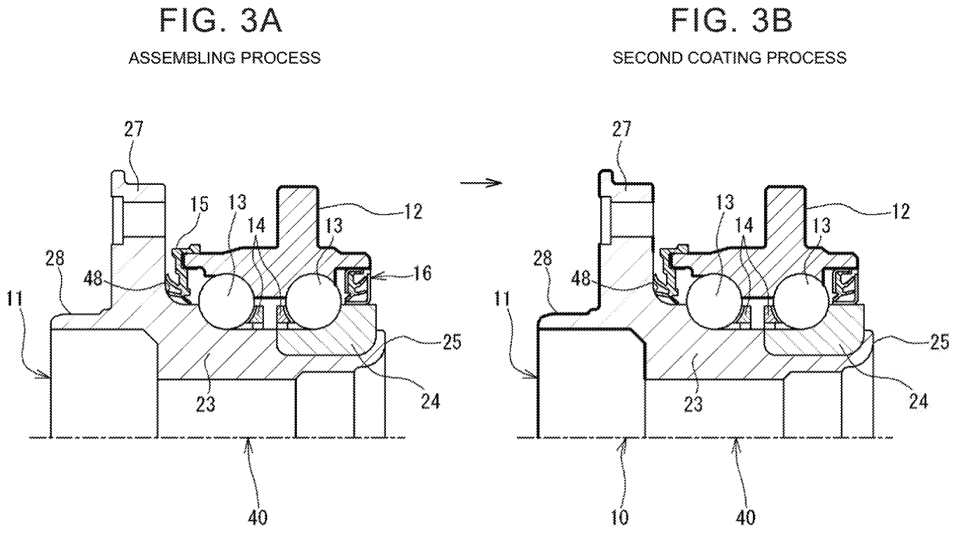

A manufacturing method for the bearing device 10 in which a coating is applied to the inner shaft member 11 and the outer ring member 12 will be described. FIG. 2A to FIG. 3B are views illustrating the manufacturing method for the bearing device 10. The bearing device 10 including the inner shaft member 11 and the outer ring member 12 is manufactured through a plurality of processes. Intermediate products of the constituent components, such as the inner shaft 23, included in the bearing device 10 are also referred to by the names of the constituent components, such as the inner shaft 23, in the present embodiment.

### Working and Heat Treatment Process

As shown in FIG. 2A, the outer ring member 12 is manufactured by cutting a forging having a predetermined shape, and the outer ring member 12 is subjected to heat treatment (quenching and tempering). As shown in FIG. 2B, the inner shaft 23 of the inner shaft member 11 is manufactured by cutting another forging, and the inner shaft 23 is subjected to heat treatment (quenching and tempering).

### First Coating Process

As shown in FIG. 2C, a coating is applied to the heat-treated outer ring member 12. The coating is applied all over the outer ring member 12. A coating is applied to the outer ring member 12 solely, that is, in a discrete component. The word “solely” means that no other component (constituent member) is assembled to the outer ring member 12. In the present embodiment, a coating is applied to the outer ring member 12 by hot-dip galvanizing. In this case, coating (plating) is performed at the same time with many other outer ring members 12. In this way, the case where the same process (the process of applying a coating) is performed at the same time with other outer ring members 12 without assembling another component (constituent member) to the outer ring member 12 is also included in the word “solely”.

### Grinding Process

As shown in FIG. 2D, required portions of the coated outer ring member 12 are ground. In the present embodiment, the portion 66 of the outer periphery 62 and the outer raceway surfaces 12a, 12b are to be ground. The reason why the portion 66 of the outer periphery 62 is ground is to set the portion 66 for a working reference plane for machining the outer raceway surfaces 12a, 12b. For this reason, the portion 66 is ground first. The ground portion 66 is covered with the outer lip 34 of the seal 15 (see FIG. 4), and is not exposed to the outside. In FIG. 4, the area to be covered with the outer lip 34 includes not only the ground portion 66 but also a portion 72 of the coating that adjoins the portion 66. In FIG. 4, the coated portions are shown by the wide lines, and the uncoated portions are shown by the lines narrower than the wide lines. In this way, in the grinding process (FIG. 2D), after the first coating process (FIG. 2C), the outer ring member 12 is machined (ground) for forming the outer raceway surfaces 12a, 12b, and part of the coating is removed. To form the outer raceway surfaces 12a, 12b, the portion 66 of the outer periphery 62 is machined (ground), and part of the coating is removed. This grinding process is a removal process of removing part of the coating from the outer ring member 12.

As shown in FIG. 2E, required portions of the heat-treated inner shaft 23 are ground. In the present embodiment, the inner raceway surface 11a, the surface 60 with which the inner ring 24 contacts, and the outer periphery of the cylindrical portion 25a that will be the clinch portion 25 (see FIG. 1) are to be ground. In this way, in the grinding process, the heat-treated inner shaft 23 is machined (ground) for forming the inner raceway surface 11a, and the like.

### Assembling Process

As shown in FIG. 3A, in an assembling process, the outer ring member 12, the inner shaft member 11, the balls 13 that are rolling elements, and the cages 14 are assembled into an assembly 40. Here, the outer ring member 12 has a coating, and part of the coating has been removed by machining. The inner shaft member 11 is in a state after the inner ring 24 is mounted on the inner shaft 23, and no coating is applied to these components. The inner shaft 23 has been machined for forming the inner raceway surface 11a, and the like. The balls 13 and the cages 14 are manufactured ones.

In the assembling process, the order of assembling the constituent components included in the bearing device 10 is as follows.

(1) The inner shaft 23 and the outer ring member 12 are assembled to each other. At this time, the balls 13 and the cage 14 at one side in the axial direction are interposed between the inner shaft 23 and the outer ring member 12. In addition, the seal 15 at one side in the axial direction is mounted.
(2) The inner ring 24 is fitted onto the inner shaft 23. At this time, the balls 13 and the cage 14 at the other side in the axial direction are interposed between the inner ring 24 and the outer ring member 12. In addition, the seal 16 is mounted at the other side in the axial direction.
(3) The end portion of the inner shaft 23 in the axial direction is clinched (wobble clinching), and the clinch portion 25 is formed.
Thus, the assembly 40 is obtained.

### Second Coating Process

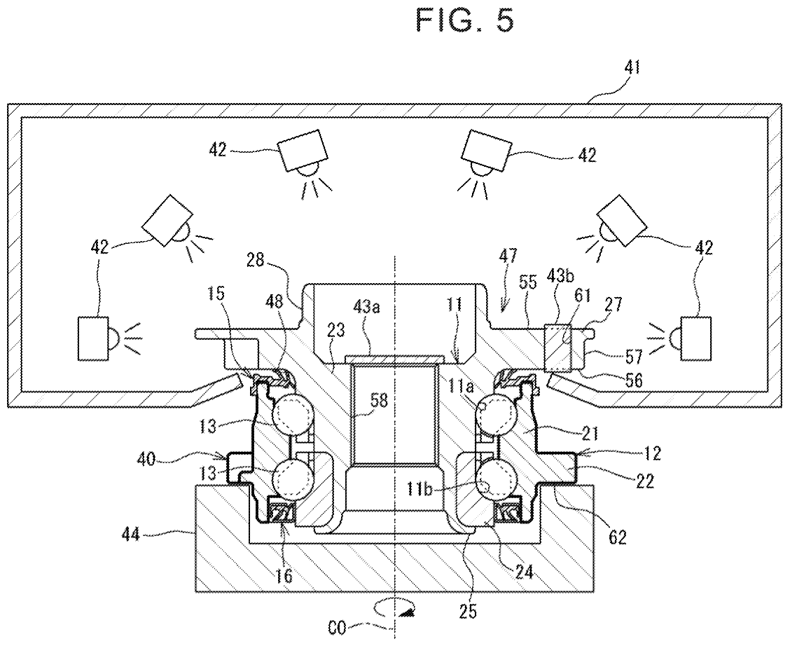

A coating is applied to required portions of the inner shaft member 11 in the assembly 40. Work for applying a coating to the inner shaft member 11 is performed over the assembly 40. In the present embodiment, a coating is applied by spray painting. FIG. 5 is a view illustrating a second coating process. In this second coating process, a coating is applied to one side of the inner shaft 23 in the axial direction, including the flange 27. In contrast to this, no coating is applied to the inner ring 24 and the clinch portion 25 that are at the other side in the axial direction.

To perform such a second coating process, as shown in FIG. 5, one side portion 47 of the inner shaft member 11 in the axial direction, including the flange 27 and the cylindrical portion 28, is placed in a paint chamber 41. In contrast to this, the other side of the inner shaft member 11 in the axial direction where the first seal 15 and the clinch portion 25 are provided, that is, the first seal 15, the second seal 16, the balls 13, the cages 14, and the outer ring member 12, are placed outside the paint chamber 41. In this state, work for applying a coating is performed in the paint chamber 41. In the case of the present embodiment, the work is performed by spraying application liquid (coating material) from a plurality of nozzles 42 installed inside the paint chamber 41. Mask members 43a, 43b are provided at portions that do not require a coating in the portion 47 at one side in the axial direction. Since no coating is required on the inner periphery 58 of the inner shaft 23, the mask member 43a is provided at the end portion of the inner periphery 58. In addition, the mask member 43b is also provided at the bolt hole 61. In the second coating process, the assembly 40 is placed on a turn base 44. While the assembly 40 is turned about the bearing central axis CO by the turn base 44, application liquid is injected from the nozzles 42 toward the assembly 40. Thus, a coating is applied to required portions of the inner shaft member 11.

### Manufacturing Method of Present Embodiment

As described above, the manufacturing method of the present embodiment is a method in which a coating is applied solely all over the outer ring member 12 and a coating is applied to the inner shaft member 11 after the assembly 40 is formed. More specifically, the manufacturing method of the present embodiment includes the first coating process (see FIG. 2C), the grinding process that is the removal process (see FIG. 2D), the assembling process (see FIG. 3A), and the second coating process (see FIG. 3B). In the first coating process, a coating is applied solely all over the outer ring member 12. In the removal process (grinding process), after the first coating process, part of the coating is removed by machining (grinding) the outer ring member 12 for forming the outer raceway surfaces 12a, 12b with which the balls 13 come into rolling contact. In the assembling process, the coated outer ring member 12, the inner shaft member 11 before a coating is applied, the balls 13, and the cages 14 are assembled into the assembly 40. In the second coating process, a coating is applied to required portions of the inner shaft member 11 in the assembly 40.

With this manufacturing method, a coating is applied to the required portions of the inner shaft member 11 and outer ring member 12, so it is possible to reduce formation of rust overall. With the manufacturing method, work for removing part of the coating is performed only over the outer ring member 12 (removal process). In the second coating process, work for applying a coating to the required portions of the inner shaft member 11 in the assembly 40 is performed. At this time, it is possible to hold the already coated outer ring member 12 (see FIG. 5), so holding of the bearing device 10 does not interfere with work for applying a coating to the inner shaft member 11. As shown in FIG. 5, in the second coating process, the assembly 40 is held at the outer periphery 62 of the outer ring member 12.

In the first coating process (FIG. 2C), when hot-dip galvanizing is used in the process of applying a coating to the outer ring member 12, many outer ring members 12 can be processed at the same time, so it is advantageous in terms of cost. In addition, no masking member needs to be put on the outer ring member 12, so work is easy.

In the second coating process of the present embodiment, as shown in FIG. 5, a coating is applied to one side of the inner shaft 23 in the axial direction, including the flange 27. Therefore, no coating is applied to the inner raceway surface 11a of the inner shaft member 11, and no coating is applied to the inner ring 24 (inner raceway surface 11b) and the clinch portion 25. Since no coating is applied to the clinch portion 25, no foreign matter caused by peeling of a coating appears at the time of wobble clinching. That is, if a coating is applied to the inner shaft member 11 and a coating is also applied to the clinch portion 25 before assembling, the coating of the clinch portion 25 peels off at the time of wobble clinching. If a peeled coating adheres to, for example, the balls 13, the peeled coating may cause a malfunction of the bearing device 10.

As shown in FIG. 5, the other side of the inner shaft 23 in the axial direction where the seal 15 and the clinch portion 25 are provided is placed outside the paint chamber 41, and work for applying a coating is performed inside the paint chamber 41. Therefore, the seal 15 does not need to be masked.

### Bearing Device 10

The bearing device 10 manufactured through the manufacturing method is as follows. As shown in FIG. 1, in the outer ring member 12, the outer raceway surfaces 12a, 12b are metal surfaces from which the coating has been removed, and the outer periphery 62 (except the portion 66 covered with the outer lip 34) is a coated surface. In the inner shaft member 11, a coating is applied to the portion 47 at one side in the axial direction, including the flange 27 and the cylindrical portion 28. In contrast to this, in the inner shaft member 11, the inner raceway surface 11a, the surface of the inner ring 24, and the surface of the clinch portion 25 are metal surfaces to which no coating is applied. In this way, a coating is applied to the required portions of the inner shaft member 11 and outer ring member 12, so it is possible to reduce formation of rust overall.

The coating of the inner shaft member 11 is an application film obtained by drying application liquid. This application film is formed by laminating a plurality of films. For example, the coating of the inner shaft member 11 contains an under coat layer, an intermediate coat layer, and a top coat layer as the plurality of films. The top coat layer is a finishing layer that is the outermost layer. In the bearing device 10 manufactured through the manufacturing method of the present embodiment, in the coating of the portion 47 at one side of the inner shaft member 11 in the axial direction, the finishing layer that is the outermost layer is a continuous layer.

In contrast to this, as in the case of the above-described Method 1, when a coating is applied solely all over the outer ring member 12 and all over the inner shaft member 11 and then a bearing device is assembled in the same order as that of the present embodiment, a finishing layer that is the outermost layer is not a continuous layer in the coating of the portion 47 at one side of the inner shaft member 11 in the axial direction. When Method 1 is used as well, the description will be made by using the signs used in the present embodiment. In this case, the assembly 40 is obtained by performing wobble clinching as described above, and a jig is brought into contact with the flange 27 to support reaction force for the wobble clinching. Therefore, part of the coating of the flange 27 (flange face 55) is damaged during wobble clinching, and the coating of that portion (damaged portion) is repaired (touched up) after completion of assembling. Hence, in this case, a coating is overlappingly applied at part of the flange 27 (flange face 55), and a finishing layer (outermost layer) is partially not a continuous layer. Therefore, with Method 1, the flange 27 can be unfavorable in appearance. In the bearing device 10 of the present embodiment, in the coating of the portion 47 at one side of the inner shaft member 11 in the axial direction, the finishing layer that is the outermost layer is a continuous layer, so the flange 27 that is favorable in appearance is obtained.

In the case of the bearing device 10 manufactured through the manufacturing method of the present embodiment, the portion 66 of the outer periphery 62 of the outer ring member 12 is a metal surface (machined surface) (see FIG. 4). The metal surface (portion 66) and the portion 72 of the coating that adjoins the metal surface (portion 66) are covered with the outer lip 34.

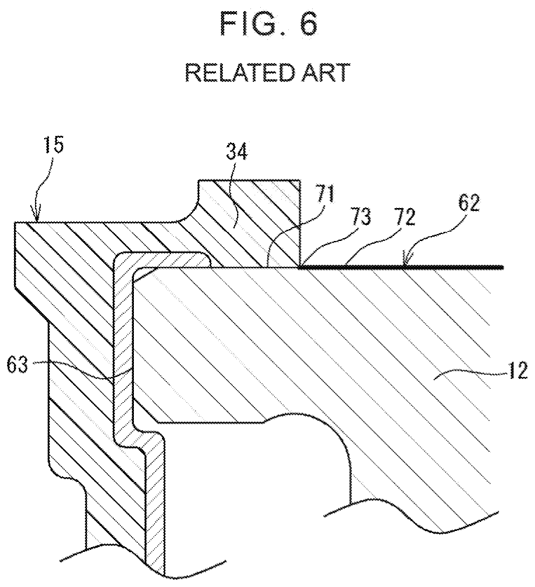

In contrast to this, as in the case of the above-described Method 2, when a coating is applied to the inner shaft member 11 and the outer ring member 12 by painting, such as spraying, after completion of assembling, the coating is as shown in FIG. 6. In FIG. 6, the outline of the coated portion is shown by the wide line. In contrast to this, the outlines of the uncoated portions are shown by the lines narrower than the wide line. That is, even when a coating is applied by painting, such as spraying, in a state where part of the outer periphery 62 of the outer ring member 12 is covered with the outer lip 34 and a portion 71 of the outer periphery 62 that is a metal surface is covered with the outer lip 34, the portion 72 of the coating that adjoins the metal surface (portion 71) is not covered with the outer lip 34. Therefore, water can enter a boundary 73 between the metal surface (portion 71) covered with the outer lip 34 and the portion 72 of the coating that adjoins the metal surface (portion 71), so corrosion performance is low. In the bearing device 10 of the present embodiment (see FIG. 4), the portion 72 of the coating that adjoins the metal surface (portion 66) is covered with the outer lip 34. The boundary 73 between the metal surface (portion 66) and the coating (portion 72) is completely covered with the outer lip 34, so corrosion performance is high.

The outer ring member 12 and the inner shaft member 11 may have the coatings of the same specifications. Alternatively, the outer ring member 12 and the inner shaft member 11 may have the coatings of the different specifications. In the case of the different specifications, appropriate coatings can be selected for the outer ring member 12 and the inner shaft member 11, respectively. In the present embodiment, the specifications of the coating of the outer ring member 12 are plating (hot-dip galvanizing), and the specifications of the coating of the inner shaft member 11 are painting (for example, painting through zinc flake coating). These specifications may be changed.

The embodiment described above is illustrative and not restrictive in all respects. The scope of the invention is not limited to the above-described embodiment. The scope of the invention encompasses all the modifications within the scope of the elements described in the appended claims and equivalents thereof.

The specifications (type) of the coating may be other than hot-dip galvanizing or painting, and the coating just needs to have the function of reducing formation of rust. In the embodiment, the case where the inner shaft 23 has a cylindrical shape is described. Instead, the inner shaft 23 may have a shape other than the cylindrical shape. In addition, as another manufacturing method, a coating may be applied solely all over the inner shaft member 11 (inner shaft 23), and then part of the coating may be removed by machining the inner shaft member 11 (inner shaft 23) for forming the inner raceway surface 11a. After that, the coated inner shaft member 11 (inner shaft 23), the outer ring member 12, the rolling elements (balls 13), and the cages 14 may be assembled into an assembly, and a coating may be applied to required portions of the outer ring member 12 in the assembly.

What is claimed is:

1. A manufacturing method for a bearing device including an inner shaft member, an outer ring member that has cylindrical shape and is provided on an outer side of the inner shaft member in a radial direction, a plurality of rolling elements that are provided between the inner shaft member and the outer ring member, and a cage that holds the plurality of rolling elements, the manufacturing method comprising:
a first coating process of applying a coating solely all over a first member that is one of the inner shaft member and the outer ring member;
a removal process of, after the first coating process, removing part of the coating by machining the first member for forming a raceway surface for rolling contact with the rolling elements;
an assembling process of assembling the coated first member, a second member, the rolling elements, and the cage into an assembly, the second member being the other one of the inner shaft member and the outer ring member; and
a second coating process of applying a coating to a required portion of the second member in the assembly.

2. The manufacturing method according to claim 1, wherein:
the first member is the outer ring member;
the second member is the inner shaft member;
the inner shaft member includes an inner shaft having a flange at one side in an axial direction, an inner ring that has annular shape and is mounted at the other side of the inner shaft in the axial direction, and a clinch portion that is part of the inner shaft and that is provided to prevent the inner ring from coming off to the other side in the axial direction; and
in the second coating process, a coating is applied to one side of the inner shaft in the axial direction, includes the flange.

3. The manufacturing method according to claim 2, wherein:
the bearing device further includes a seal that is provided on one side of an annular space in the axial direction, the annular space is provided between the inner shaft member and the outer ring member; and
in the second coating process, a portion of the inner shaft member at one side in the axial direction, including the flange, is placed inside a paint chamber, the other side in the axial direction where the seal and the clinch portion are provided, is placed outside the paint chamber, and work for applying a coating is performed inside the paint chamber.

4. A bearing device comprising:
an inner shaft member;
a outer ring member that has cylindrical shape and is provided on an outer side of the inner shaft member in a radial direction;
a plurality of rolling elements provided between the inner shaft member and the outer ring member; and
a cage that holds the plurality of rolling elements, wherein:
the inner shaft member includes an inner shaft, an inner ring that has annular shape, and a clinch portion;
the inner shaft includes a flange at one side in an axial direction and a cylindrical portion that extends from the flange further toward the one side in the axial direction;
the inner ring is mounted at the other side of the inner shaft in the axial direction;
the clinch portion is part of the inner shaft at the other side in the axial direction and is provided to prevent the inner ring from coming off to the other side in the axial direction;
in the outer ring member, a raceway surface with which the rolling elements are in rolling contact is a metal surface, and an outer periphery is a coated surface; and
in the inner shaft member, a coating is applied to a portion at one side in the axial direction, including the flange and the cylindrical portion, and a raceway surface with which the rolling elements are in rolling contact, a surface of the inner ring, and a surface of the clinch portion are metal surfaces.

5. The bearing device according to claim 4, further comprising a seal on one side of an annular space in the axial direction, the annular space being provided between the inner shaft member and the outer ring member, the seal including an outer lip that covers part of an outer periphery of the outer ring member, wherein:
in the coating of the inner shaft member, a finishing layer that is an outermost layer is a continuous layer; and
the part of the outer periphery of the outer ring member is a metal surface, and
the metal surface and part of the coating that adjoins the metal surface are covered with the outer lip.

6. The bearing device according to claim 4, wherein the outer ring member and the inner shaft member have different specifications of coatings.
